(19) United States
(12) Patent Application Publication
(10) Pub. No.: US 2003/0124260 A1
(43) Pub. Date: Jul. 3, 2003

(54) Method for forming metal pattern

(76) Inventor: Myoung-Kee Baek, Seoul (KR)

Correspondence Address: BIRCH STEWART KOLASCH & BIRCH, PO BOX 747, FALLS CHURCH, VA, 22040-0747, US

(21) Appl. No.: 10/329,422

(22) Filed: Dec. 27, 2002

(30) Foreign Application Priority Data
Dec. 28, 2001 (KR) 87437/2001

(51) Int. Cl. B05D 5/12; B05D 1/32; B05D 3/02; B05D 1/02

(52) U.S. Cl. 427/384; 427/58; 427/421; 427/282

(57) ABSTRACT

A method for providing a metal pattern forms a metal pattern of a display device or a semiconductor device. The method includes printing a conductive organic material such as poly 3,4-ethylenedioxythiophen (PEDOT) using a simple printing method such as an ink jet printing, a screen printing and a gravure printing method, where the printed material defines the metal pattern.

The present application claims the priority benefit of Korean Patent Application No. 87437/2001 filed on Dec. 28, 2001, the entire contents of which are herein fully incorporated by reference.

### BACKGROUND OF THE INVENTION

1. Field of the Invention

The present invention relates to a method for forming a metal pattern, and particularly, to a method for printing a metal pattern which is able to form a metal pattern of a display device such as a liquid crystal display device or a semiconductive device in a simple printing method using a conductive organic material such as poly 3,4-ethylenedioxythiophen (PEDOT).

2. Description of the Background Art

A display device, especially a flat panel display device such as a liquid crystal display (LCD) device, is driven by an active driving device such as a thin film transistor (TFT) disposed at each pixel area, and this driving method is called as an active matrix driving mode. In this active matrix driving mode, the active devices are disposed at the respective pixel areas which are arranged in a matrix form to drive the corresponding pixels.

FIG. 1 is a view showing an LCD device of active matrix driving mode. The LCD device shown in FIG. 1 is a TFT LCD using TFTs as the active devices. As shown therein, each pixel area of the TFT LCD having the N×M pixels disposed in the longitudinal and transverse directions, includes a TFT which is formed at a crossed region of a gate line 4 to which a scan signal is applied and of a data line 6 to which an image signal is applied. The TFT comprises a gate electrode 3 connected to the gate line 4; a semiconductor layer 8 formed on the gate electrode 3 and activated as the scan signal is applied to the gate electrode 3; and a source electrode 5 and a drain electrode 9 formed on the semiconductor layer 8. And a pixel electrode 10 of a pixel 1 is electrically connected to the drain electrodes 9 to operate liquid crystal (not shown), and receives an image signal through the source and drain electrodes 5 and 9 as the semiconductor layer 8 is activated.

FIG. 2 is a cross-sectional view showing a more-detailed structure of the TFT disposed in the respective pixel area as shown in FIG. 1. As shown in FIG. 2, the TFT comprises a substrate 20 made of a transparent insulating material such as a glass; the gate electrode 3 formed on the substrate 20; a gate insulating layer 22 deposited throughout the entire substrate on which the gate electrode 3 is formed; the semiconductor layer 8 formed on the gate insulating layer 22 and activated as a signal is applied to the gate electrode 3; the source electrode 5 and the drain electrode 9 formed on the semiconductor layer 8; and a passivation layer 25 formed on the source electrode 5 and the drain electrode 9 to protect the device.

The drain electrode 9 of the above TFT is electrically connected to the pixel electrode 10 formed in the pixel area. As a signal is applied to the pixel electrode 10 through the source electrode 5 and the drain electrode 9, an image is displayed on the pixel 1.

In the active matrix type display device such as the above discussed LCD device, a size (length/width) of the respective pixel is in the tens of μm, and therefore, the active device such as the TFT disposed in the pixel should have a width/length dimension of few μm. Moreover, as the need for high image quality display devices such as HDTVs increases, more pixels need to be disposed on a screen of the same area. Therefore, the active device pattern (including the gate line and data line patterns) disposed in the pixel needs to have finer patterns.

On the other hand, in order to fabricate the active device such as the TFT conventionally, metal patterns such as the electrode or line of the active device are formed with a photolithography method using an exposure device. A general method for forming the metal pattern will be described in brief with reference to FIGS. 3A-3D.

As shown in FIG. 3A, a metal layer 23a is formed by an evaporation process such as a sputtering process on the entire substrate 20. Thereafter, a photoresist 27a is applied thereon. In addition, as shown in FIG. 3B, a mask 29 is provided over the upper part of the substrate 20 to block some areas of the photoresist 27a, and ultraviolet ray is irradiated to the photoresist 27a. After that, a developer is applied thereon to form a photoresist layer 27 having a certain pattern on the metal layer 23a, as shown in FIG. 3C. The pattern of the photoresist layer 27 is for forming a desired metal pattern, and the portions of the metal layer 23a which are not blocked by the photoresist layer 27 are etched by an etchant. Consequently, the desired metal pattern 23 is formed on the substrate 20 as shown in FIG. 3D.

As described above, when the metal pattern is formed by the general photolithography process, there are required many processes such as the metal layer deposition process, the photoresist application process, the ultraviolet ray irradiation process, the photoresist development process and the metal layer etching process. In addition, devices of high price such as ultraviolet equipment, mask, developer and etchant equipment are also needed. Therefore, the fabricating time is increased to lower the fabrication efficiency, and the fabrication cost is also greatly increased due to the use of costly equipment.

### SUMMARY OF THE INVENTION

Therefore, an object of the present invention is to provide a method for forming a metal pattern which is able to fabricate a metal pattern in a simple way and to reduce the fabrication cost of the metal pattern by forming the metal pattern after printing a conductive organic material such as poly 3,4-ethylenedioxythiophen(PEDOT) in a printing method.

Another object of the present invention is to provide a method of forming a metal pattern which overcomes the problems and limitations of conventional methods for forming metal patterns.

To achieve these objects of the present invention, as embodied and broadly described herein, there is provided a method for forming a metal pattern according to a first embodiment of the present invention comprising: a step of preparing a substrate; a step of supplying poly 3,4-ethylenedioxythiophen (PEDOT) to a nozzle located on the substrate; a step of exhausting and depositing the PEDOT through an opening of the nozzle as the nozzle proceeds on the substrate; and a step of curing the deposited PEDOT.

In one embodiment, the viscosity of the PEDOT is 10˜30 pas, a thickness of the PEDOT deposited on the substrate is decided according to a size of the nozzle opening, the opening/closing of a valve installed on the nozzle, and the proceeding speed of the nozzle.

Also, there is provided a method for forming a metal pattern according to a second embodiment of the present invention comprising: a step of preparing a substrate; a step of disposing a screen on the substrate; a step of applying PEDOT on the screen; a step of compressing the screen with a squeeze unit and making the PEDOT permeate through the screen to deposit the PEDOT on the substrate; and a step of curing the deposited PEDOT.

Also, there is provided a method for forming a metal pattern according to a third embodiment of the present invention comprising: a step of preparing a substrate; a step of filling PEDOT into a recess of a cliche corresponding to a position of a metal pattern to be formed; a step of transferring the PEDOT filled in the recess onto a surface of a transfer roll by rotating the transfer roll; a step of re-transferring the PEDOT from the surface of the transfer roll to the substrate by rotating the transfer roll; and a step of curing the retransferred PEDOT.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a plane view showing a structure of a general liquid crystal display device;

FIG. 2 is a cross-sectional view showing a structure of a thin film transistor formed in a respective pixel of the liquid crystal display device of FIG. 1;

FIGS. 3A-3D are cross-sectional views showing a general method for forming a metal pattern in a display device or in a semiconductor device;

FIGS. 4A and 4B are views illustrating a method for forming a metal pattern according to a first embodiment of the present invention;

FIGS. 5A and 5B are views illustrating a method for forming a metal pattern according to a second embodiment of the present invention;

FIGS. 6A and 6B are views showing an operation of a squeeze in the second embodiment of the present invention; and

FIGS. 7A-7C are views illustrating a method for forming a metal pattern according to a third embodiment of the present invention.

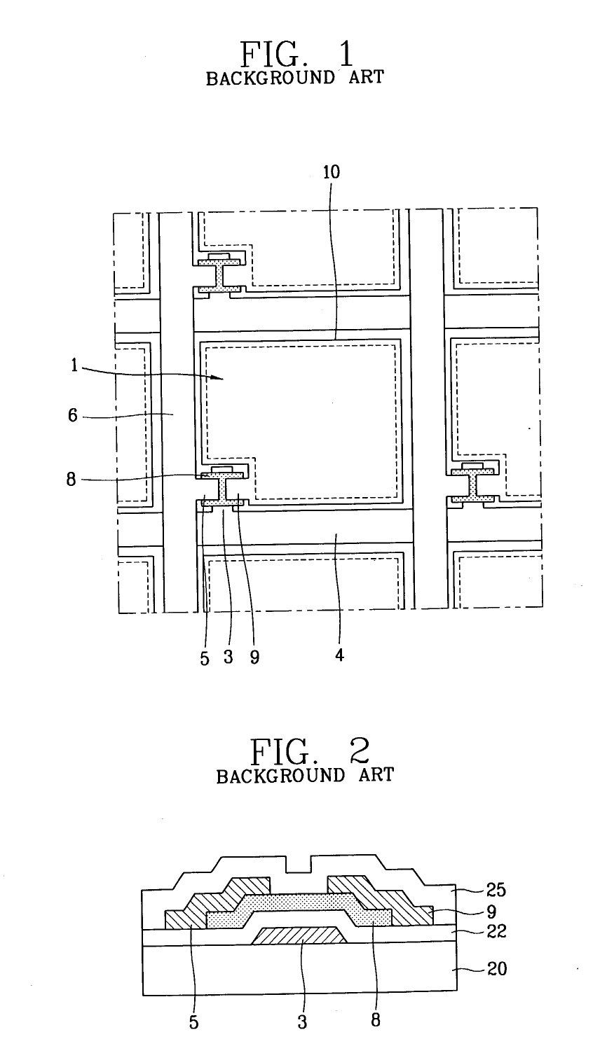

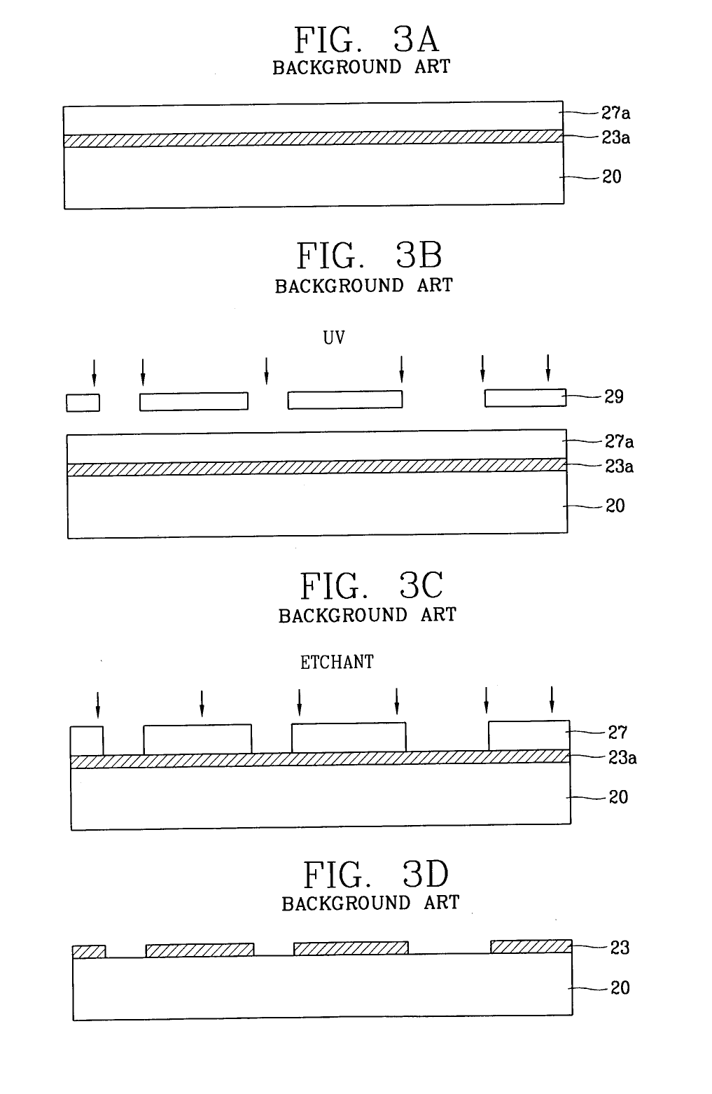

### DETAILED DESCRIPTION OF THE PREFERRED EMBODIMENTS

Reference will now be made in detail to the preferred embodiments of the present invention, examples of which are illustrated in the accompanying drawings.

The present invention provides a method for forming a metal pattern. Particularly, the metal pattern is formed by a simple process such as a printing method, not by a complex process such as a photolithography method. In the present invention, a conductive high molecular material such as poly 3,4-ethylenedioxythiophen (PEDOT) is used as a material forming the metal pattern. The PEDOT is made by polymerizing monomer such as 3,4-ethylenedioxythiophen (EDOT) electrochemically or chemically, and has advantages such as a high processability and a low weight when compared to other general metals used for electrodes.

In the present invention, the PEDOT is printed by a printing device to form the metal pattern. Generally, the PEDOT has a viscosity of 7 mPas. However, the above viscosity has high fluidity, and therefore, a certain shape can not be maintained in the printing process. Thus, the viscosity of the PEDOT is set to be at or about 10˜30 Pas, which is 1000 times as large as 7 mPas, in order to form a firm metal pattern.

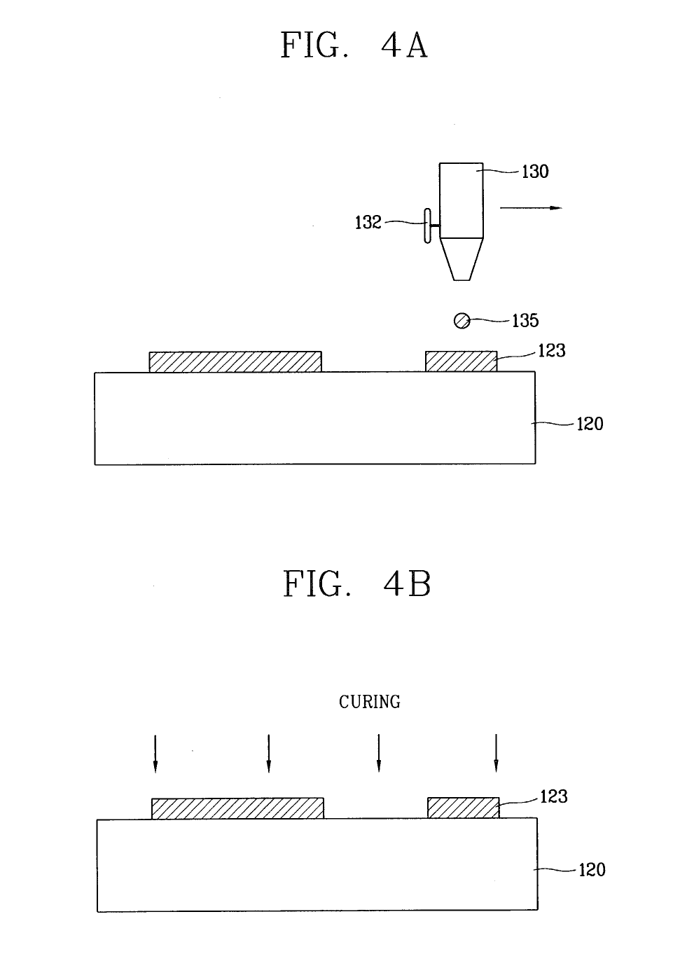

Hereinafter, the methods for forming the metal pattern by printing PEDOT according to the embodiments of the present invention will be described with reference to FIGS. 4A-7C.

FIGS. 4A and 4B are views illustrating a method for forming a metal pattern according to a first embodiment of the present invention. Here, the metal pattern is formed by using an ink jet printing.

As shown in FIG. 4A, a nozzle 130 having an opening of a certain size is provided over a substrate 120 such as a transparent glass substrate, a flexible plastic substrate, an opaque insulating substrate, or any other suitable substrate. Although it is not shown in FIG. 4A, the nozzle 130 is connected to a supply unit which is filled with the PEDOT 135. The PEDOT 135 is then supplied to the nozzle 130.

The PEDOT 135 supplied to the nozzle 130 is exhausted from the opening of the nozzle 130 and deposited on the substrate 120. At that time, since a valve 132 for controlling an amount of PEDOT 135 exhausted from the nozzle 130 is installed on the nozzle 130, the PEDOT 135 of a desired amount can be deposited on the substrate 120. In addition, since the nozzle 130 proceeds on the substrate 120 at a certain speed (v1), the PEDOT 135 can be deposited throughout the entire substrate 120. The PEDOT 135 can be deposited at desired positions of the substrate 120 by controlling the valve 132.

The amount of the PEDOT 135 deposited on the substrate 120 (that is, a thickness of a metal pattern which will be deposited) can be varied from various elements. For example, there are certain factors that decide the deposited thickness of the PEDOT, such as the size of nozzle opening, opening/closing degree of the valve 132, the viscosity of the PEDOT, and the proceeding speed of the nozzle 130. Therefore, the first embodiment of the present invention is able to form the metal pattern of a desired thickness and size by controlling one or more of the above-identified factors.

As described above, the PEDOT exhausted from the nozzle 130 has high viscosity, but also has a certain fluidity. Therefore, the deposited PEDOT (metal pattern) 123 should be cured as shown in FIG. 4B. The curing is made by heating the PEDOT 123 or irradiating light onto the PEDOT 123. Here, the amount of applied heat or light is decided by the viscosity of the PEDOT and/or by the thickness of the deposited PECOT 123.

In the method for forming the metal pattern by the above-discussed ink jet printing, the PEDOT exhausted from the nozzle 130 is deposited on the substrate 120 to form a metal pattern; however, the deposition of the PEDOT exhausted from the nozzle 130 can be made only on a local area. Therefore, in order to form the various metal patterns on a substrate of a larger area, the exhausting process (deposition process) of the PEDOT is repeated as the nozzle 130 is moved.

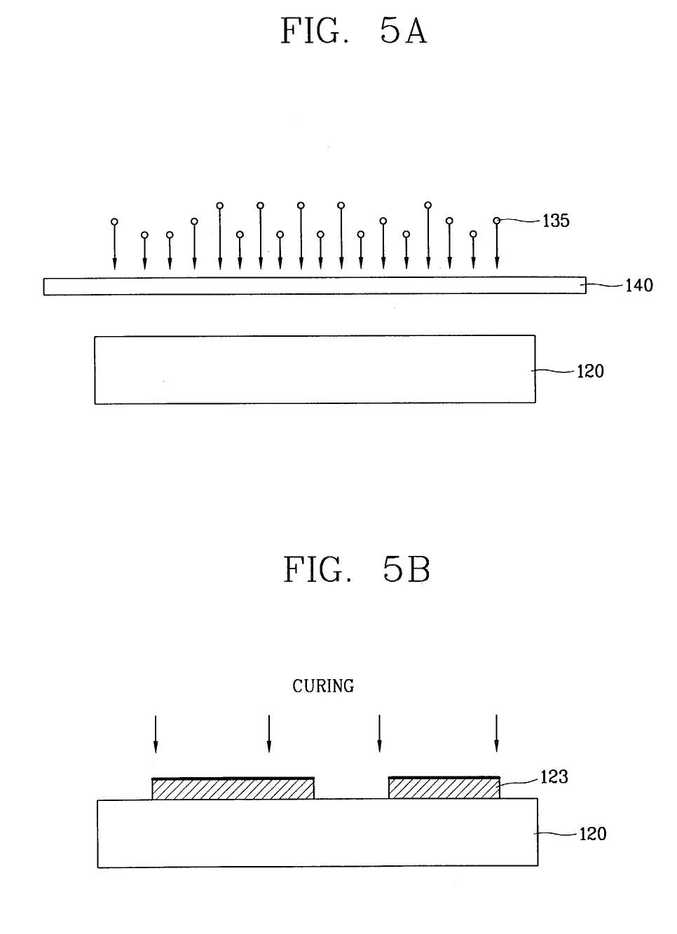

FIGS. 5A and 5B illustrate a method for forming a metal pattern according to a second embodiment of the present invention, in which the metal pattern is formed on the substrate of a large area using a screen printing process.

As shown in FIGS. 5A and 5B, a screen 140 is provided over the substrate 120. In this example, the screen 140 is a porous screen having many tiny holes. Then the particles of the PEDOT 135 are deposited on the substrate 120 through the porous screen 140, i.e., through the holes of the screen 140. In this manner, the screen 140 functions as a mask. That is, the fine holes are formed only at certain positions on the screen 140 corresponding to the desired metal pattern, and are not formed at other areas. Therefore, the PEDOT 135 is permeated through the fine holes of the screen 140 to form the desired metal pattern on the substrate 120. As described above, the PEDOT (metal pattern) 123 deposited on the substrate 120 is completed after being cured as in the ink jet method shown in FIG. 4B. The dimensions and the number of the holes on the screen 140, and the dimensions (e.g., thickness) of the screen 140 may vary depending on the desired metal pattern and other factors. By the method of FIGS. 5A and 5B, the entire metal pattern may be formed simultaneously as the PEDOT passes through the screen 140.

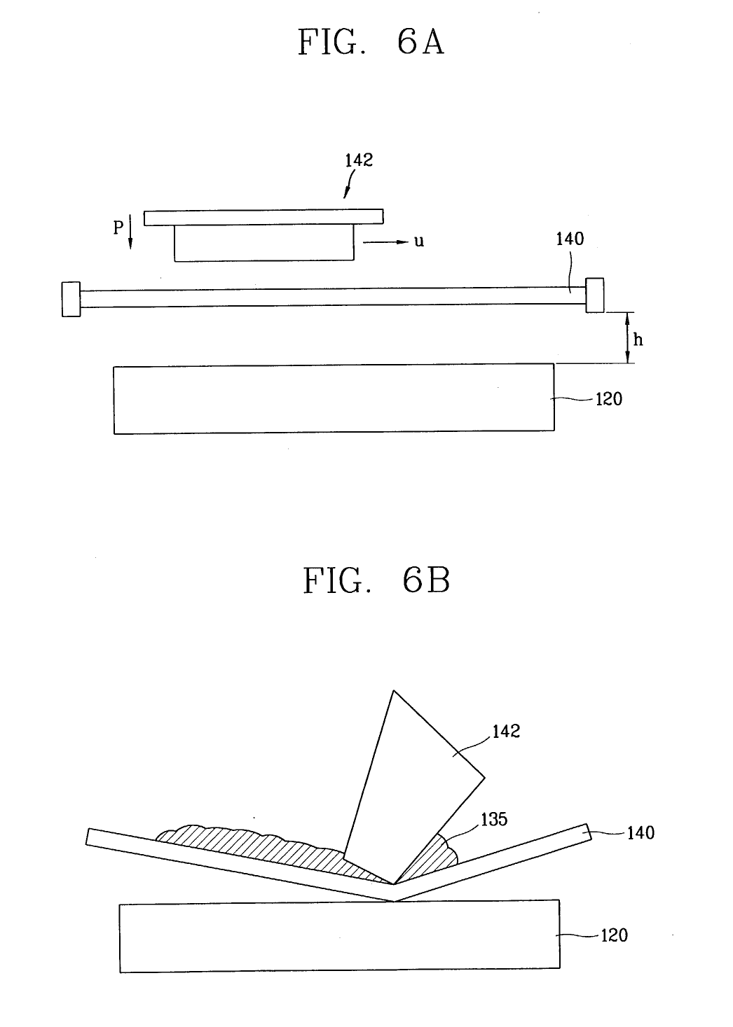

FIGS. 6A and 6B illustrate a variation of the screen printing method of the second embodiment.

As shown in FIG. 6A, the PEDOT (not shown) is applied on the screen 140 which is provided over the substrate 120 with a certain distance “h” therebetween. A squeeze unit 142 is provided over the screen 140. The screen 140 as discussed above has holes corresponding to the desired metal pattern. The squeeze unit 142 moves at a certain speed (u) in a state of compressing the screen 140 with a certain pressure (P), and the PEDOT on the screen 140 is pressed down through the screen 140 by the pressure (P) to form a desired metal pattern of the PEDOT on the substrate 120. The amount of the PEDOT deposited on the substrate 120 can be varied by varying a distance between the substrate 120 and the screen 140, the pressure (P) of the squeeze unit 142 and the proceeding speed (u) of the squeeze unit 142. And these conditions are set discretionarily according to the size and/or thickness of the desired metal pattern to be formed.

As shown in FIG. 6B as the squeeze unit 142 contacts and presses down on the screen 140 by the pressure of the squeeze unit 142, the PEDOT 135 disposed on the screen 140 is pushed out onto the substrate 120 through the holes of the screen 140 by the pressure of the squeeze unit 142. As the squeeze unit 142 moves, the PEDOT is finally deposited on the substrate 120 to form the desired metal pattern thereon, by the movement and pressure of the squeeze unit 142.

In another variation, if the screen 140 and the squeeze unit 142 have a size at least as same as the size of the substrate 120 upon which the desired metal pattern is to be formed, and if a uniform pressure can be simultaneously applied to the entire screen 140 by pressing down the entire squeeze unit 142, then the entire metal pattern can be formed on the substrate, simultaneously, by using a single screen printing step.

The operation of the squeeze unit 142 can be controlled in various ways, e.g., mechanically, electrically, manually, etc. Further, various sizes and/or shapes of the squeeze unit 142 may be used.

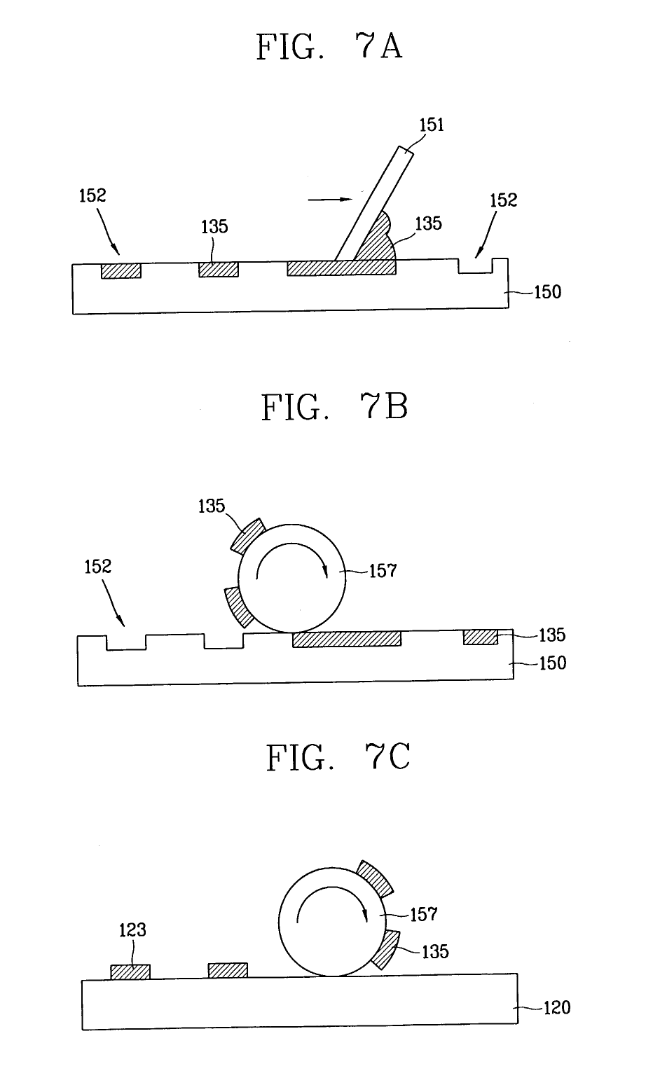

FIGS. 7A-7C illustrate a method for forming a metal pattern according to a third embodiment of the present invention. The method shown in FIGS. 7A-7C is a method for forming the metal pattern using a gravure printing method. Generally, the gravure printing is a printing method which stains a cliche with an ink, scrapes off any surplus ink, and then proceeds with the printing process. The gravure printing method is a known printing method in various fields such as publishing, packing, cellophane, vinyl and polyethylene. In the third embodiment, the gravure printing method is applied to form the metal pattern.

In the gravure printing method, PEDOT is transferred onto a substrate using a transfer roll. As a result, the metal pattern can be formed on the substrate with a single transferring step by using a transfer roll corresponding to the size of the substrate. This process will be described in more detail as follows.

As shown in FIG. 7A, one or more recesses 152 are formed on certain portions of a concave plate or a cliche 150, where the pattern of the recesses 152 corresponds to the metal pattern to be formed. These recesses 152 have generally the same depth. Then PEDOT is filled in and over the recesses 152. Here, the recesses 152 are formed finely on the cliche 150 by a general photolithography method or other suitable method. The PEDOT 135 on the cliche 150 is then scraped by moving a doctor blade 151 or the like across the cliche 150 as the end surface of the doctor blade 151 abuts the top outer surface of the cliche. By the operation of the blade 151, the PEDOT 135 is perfectly filled only in the recesses 152, and at the same time, any excess PEDOT remaining on the top outer surface of the cliche 150 is completely removed.

Thereafter, as shown in FIG. 7B, the PEDOT 135 filled in the recesses 152 of the cliche 150 is transferred onto the surface of a transfer roll 157 which rotates as it contacts the top outer surface of the cliche 150. The transfer roll 157 has the same width as that of the substrate on which the metal pattern is formed, and has a circumference same as the length of the substrate. Therefore, the PEDOT 135 filled in the recesses 152 of the cliche 150 is all transferred onto the outer circumferential surface of the transfer roll 157. In one example, the entire desired metal pattern to be formed may be transferred onto the surface of the transfer roll 157.

After that, as shown in FIG. 7C, the PEDOT 135 transferred on the transfer roll 157 is transferred onto the substrate 120 as the transfer roll 157 rotates and contacts the surface of the substrate 120. The transferred PEDOT 135 on the substrate 120 is cured to form the metal pattern 123. In different examples, the desired metal pattern 123 can be formed on the entire substrate 120 with only a single rotation of the transfer roll 157 or with the multiple rotations of one or more transfer rolls operating selectively or simultaneously.

As described above, in the method for forming the metal pattern using the gravure printing method, the cliche 150 and the transfer roll 157 can be fabricated according to the desired substrate size, and the metal pattern can be formed on the substrate 120 with one transferring. Thereby, the metal pattern of the substrate also can be formed with one process.

As described above, the present invention forms the metal pattern by printing the PEDOT, that is, the conductive organic material, in a printing method. The printing method can be used for forming the metal pattern of the display device (e.g., the LCD device or organic light emitting device), general semiconductor devices or other suitable devices. Also, other conductive organic materials having similar characteristics with the PEDOT can be used, in lieu of or in combination with the PEDOT.

In the present invention, the metal pattern is formed using the ink jet printing method, the screen printing method and the gravure printing method with the PEDOT. Therefore, the fabrication process of the metal pattern becomes simple, and the metal pattern can be formed inexpensively since costly devices such as an ultraviolet irradiation equipment or a sputtering equipment are not required.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for forming a metal pattern, comprising the steps of:
providing a substrate;
printing a conductive organic material on the substrate; and
curing the printed conductive organic material, so as to form the metal pattern on the substrate.

2. The method of claim 1, wherein the conductive organic material is poly 3,4-ethylenedioxythiophen (PEDOT).

3. The method of claim 2, wherein the PEDOT has a viscosity of about 10˜30 Pas.

4. The method of claim 1, wherein the step of printing the conductive organic material includes the steps of:
supplying the conductive organic material to a nozzle which is located over the substrate; and
exhausting and depositing the conductive organic material on the substrate through an opening of the nozzle as the nozzle is moved.

5. The method of claim 4, wherein a thickness of the conductive organic material deposited on the substrate varies depending upon a size of the opening of the nozzle opening, an opening/closing of a valve installed on the nozzle, and a moving speed of the nozzle.

6. The method of claim 1, wherein the step of printing the conductive organic material includes the steps of:
disposing a screen over the substrate; and
applying the conductive organic material on the screen, so that the conductive organic material is permeated through the screen onto the substrate.

7. The method of claim 6, wherein the applying step includes:
pressing a squeeze unit against the screen.

8. The method of claim 6, wherein, in the disposing step, the screen is porous and flexible.

9. The method of claim 6, wherein, in the disposing step, the screen has a hole pattern corresponding to the metal pattern.

10. The method of claim 7, wherein, in the processing step, a size of the squeeze unit corresponds to a size of the metal pattern, so that the entire metal pattern is simultaneously formed by pressing the entire squeeze unit uniformly.

11. The method of claim 7, wherein a thickness of the conductive organic material on the substrate varies depending upon a distance between the substrate and the screen, a pressure of the squeeze unit pressing against the screen, and a moving speed of the squeeze unit.

12. The method of claim 1, wherein the step of printing the conductive organic material includes the steps of:
filling the conductive organic material in at least one recess of a plate, a pattern of said recess corresponding to the metal pattern to be formed;
first transferring the conductive organic material in said recess, onto a surface of a transfer roll; and
second transferring the conductive organic material on the transfer roll, onto surface of the substrate

13. The method of claim 12, wherein the filling step includes:
proving the conductive organic material in and over said recess; and then scraping a top surface of the plate.

14. The method of claim 12, wherein the first transferring step transfers the conductive organic material onto the surface of the transfer roll by rotating the transfer roll in contact with the plate.

15. The method of claim 12, wherein the second transferring step transfers the conductive organic material onto the surface of the substrate by rotating, on the substrate, the transfer roll having the conductive organic material thereon.

16. The method of claim 12, wherein a circumference of the transfer roller corresponds to one dimension of the metal pattern.

17. The method of claim 12, further comprising a step of forming said recess by using a photolithography process.

18. The method of claim 1, wherein the metal pattern corresponds to elements of a display device.

19. A method for forming a metal pattern, comprising the steps of:
providing a substrate; and
printing the metal pattern on the substrate.

20. The method of claim 19, wherein the printing is performed by using an ink jet printing, a screen printing, or a gravure printing.
